(19) United States
(12) Patent Application Publication
(10) Pub. No.: US 2011/0302109 A1
(43) Pub. Date: Dec. 8, 2011

(54) METHOD AND APPARATUS USEFUL IN REVENUE GENERATION FOR EDUCATIONAL ENTITIES

(76) Inventor: Frederick Suffield, Winnipeg (CA)

(21) Appl. No.: 13/152,853

(22) Filed: Jun. 3, 2011

Related U.S. Application Data
(60) Provisional application No. 61/350,992, filed on Jun. 3, 2010.

(51) Int. Cl. G06Q 90/00; G09F 15/02; G09F 15/00

(52) U.S. Cl. 705/500; 40/606.01

(57) ABSTRACT

A method of generating revenue for an educational entity having an athletic department includes providing a display supporting structure erected at an accessible location, and arranging for athletes that have associations with the athletic department of the educational entity to each be presented with an option of having a display element customized to present viewable information on the athlete in exchange for a respective financial contribution. In response to receipt of each financial contribution, the display element is customized to display the athlete information thereon, and then supported on the display supporting structure for viewing by passersby. Revenue can be generated in perpetuity, as new athletes entering and later graduating from the educational institution provide an ongoing source of contributors.

### CROSS REFERENCE TO RELATED APPLICATIONS

This application claims benefit under 35 U.S.C. 119 of U.S. Provisional Patent Application Ser. No. 61/350,992, filed Jun. 3, 2010.

### FIELD OF THE INVENTION

The invention relates generally to revenue generation for educational entities such as universities, and more particularly with a method and apparatus useful in gaining contributions from existing and soon-to-be athletic alumni.

### BACKGROUND OF THE INVENTION

Educational institutions like universities and colleges are continuously in need of financial resources to draw upon for funding or operations, programs and departments.

Accordingly, in educational institutions with athletic departments, one of the main responsibilities of all Athletic Directors is to keep their departments within their budgets and to generate revenue for athletics at their Universities.

Applicant has developed a unique revenue generation process and associated apparatus for such educational institutions, with create the potential to raise significant funding with little initial investment when employed in the manner described herein.

### SUMMARY OF THE INVENTION

According to a first aspect of the invention there is provided a method of generating revenue for an educational entity having an athletic department, the method comprising:

(a) providing a display supporting structure erected at an accessible location where a display presenting area of the display supporting structure is viewable by passersby of the display supporting structure;

(b) arranging for current athletes or former athletes, or a combination thereof, having associations with the athletic department of the educational entity to each be presented with an option of having a display element mountable on the display supporting structure customized to present viewable information on the athlete in exchange for a respective financial contribution;

(c) in response to receipt of each financial contribution, customizing the display element to store and display the information on the athlete thereon, and supporting the display element on the display supporting structure at the viewable display presenting area.

Step (a) may comprise first acquiring a sponsor and having the sponsor contribute to erection of the display supporting structure at the accessible location.

Preferably the accessible location is on-site at a campus of the educational entity.

Preferably the information on the athlete includes identification of the athlete by name, and identification of at least one of a team on which the athlete played, a team position played by the athlete, and a year or years in which the athlete played.

Each customized display element may comprise a tablet of material on which the information is displayed.

The method may include pre-equipping display elements with fastening features prior to delivery to the accessible location according to a known, including positioning each fastening feature on each display element according to a known pattern of corresponding fastening feature at the display presenting area of the display supporting structure.

The fastening features may comprise fastener holes in the display elements and the display supporting structure that are alignable with one another for receipt of fasteners therethrough to secure the display elements to the display supporting structure.

The display supporting structure may comprise two series of support devices disposed on opposite sides of a walkway passing therebetween.

The method may include expanding the display supporting structure to accommodate addition of further customized display elements beyond an original span of the display presenting area.

The display supporting structure may comprise a series of support devices each sized to accommodate a predetermined number of display elements thereon.

Preferably the method includes, for a contributory athlete responsible for a respective contribution, removing said contributory athlete from a list of athletes to later again present the option of contributing.

Preferably the method includes keeping each customized display element viewable at the display supporting structure without requiring further contribution from the athlete whose information is displayed on said customized display element.

Preferably step (b) comprises having the option presented to athletic alumni of the educational entity.

Preferably the method also includes, for each year on an ongoing basis, carrying out step (b) for graduating athletes of the educational entity that year. In such an embodiment, carrying out of step (b) and for the graduating athletes may be carried out before expected graduation thereof.

According to a second aspect of the invention there is provided an athletic alumni display apparatus for an educational entity, the apparatus comprising:

a walkway;

a series of support devices disposed on at least one side of the walkway in a side by side configuration along the walkway, each support device defining a display face that is visible from the walkway and sized to accommodate mounting of multiple display elements at respective positions over the display face; and

a plurality of customized display elements each located on one of the support devices and each displaying information thereon on a respective alumni athlete of the educational entity.

There may be two of the series of support devices on opposing sides of the walkway.

Each series of support devices may be expandable by adding additional support devices to the series to accommodate additional customized display elements.

Each support device may be defined by a respective framework to which additional frame members are selectively attachable.

Preferably the display face of each support device is equally sized to each fit a same predetermined number of equally sized ones of the display elements.

Each support device may comprise predefined fastening features each alignable with a respective predefined fastening feature in one of the customized display elements for cooperation in fastening of the customized display element to the support device.

Each fastening feature may comprise a hole in which a fastener is receivable.

Each display element may comprise a stone tablet.

Each display device may comprise a backing material supported by and spanning between frame members to define the display face on which the plurality of customized displays are seated.

Each display device may be multi-sided, one side of the display device defining the display face and one or more other sides defining one or more additional display surfaces each facing outwardly from the display device in a different direction than the display face.

According to a third aspect of the invention there is provided a method of generating revenue for an educational entity having an athletic department, the method comprising:

(a) arranging for current athletes or former athletes, or a combination thereof, having associations with the athletic department of the educational entity to each be presented with an option of having a display element customized to present viewable information on the athlete in exchange for a respective financial contribution;

(b) in response to receipt of each financial contribution, customizing the display element and display the information on the athlete thereon; and

(c) supporting the display element on a display supporting structure erected at an accessible location where a display presenting area of the display supporting structure is viewable by passersby of the display supporting structure;

The method may comprise erecting the display supporting structure, then customizing the display element and mounting the display element on the display supporting structure at the viewable display presenting area.

Alternatively, each display element may comprise a portion of the display presenting area of the display supporting structure that is customized in step (b) to show the athlete information thereon. In this instance, the athlete information may be printed on the display presenting area before erecting the display supporting structure.

Each display supporting structure may be multi-sided and present multiple ones of said display area, each facing a respective outward direction from said display supporting structure.

### BRIEF DESCRIPTION OF THE DRAWINGS

In the accompanying drawings, which illustrate exemplary embodiments of the present invention:

FIG. 1 is a schematic overhead perspective view of an Athlete Walkway of Honor for an educational entity, such as a university.

FIG. 2 is a schematic elevational perspective view of the Athlete Walkway of Honor of FIG. 1.

FIG. 3 is a partial perspective view of a display structure of the Athlete Walkway of Honor of FIG. 1.

FIG. 4 is a partial close up view of the display structure of FIG. 3, showing the mounting of athlete plaques or tiles thereon.

FIG. 5 is a front right isometric view of a framework section of an alternate embodiment display structure for the Athlete Walkway of Honor.

FIG. 6 a right side elevational view of the framework section of FIG. 5.

FIG. 7 is a perspective view of another alternate embodiment display structure.

FIG. 8 is a perspective view of an alternate Athlete Walkway of Honor employing display structures of the type shown in FIG. 7.

### DETAILED DESCRIPTION

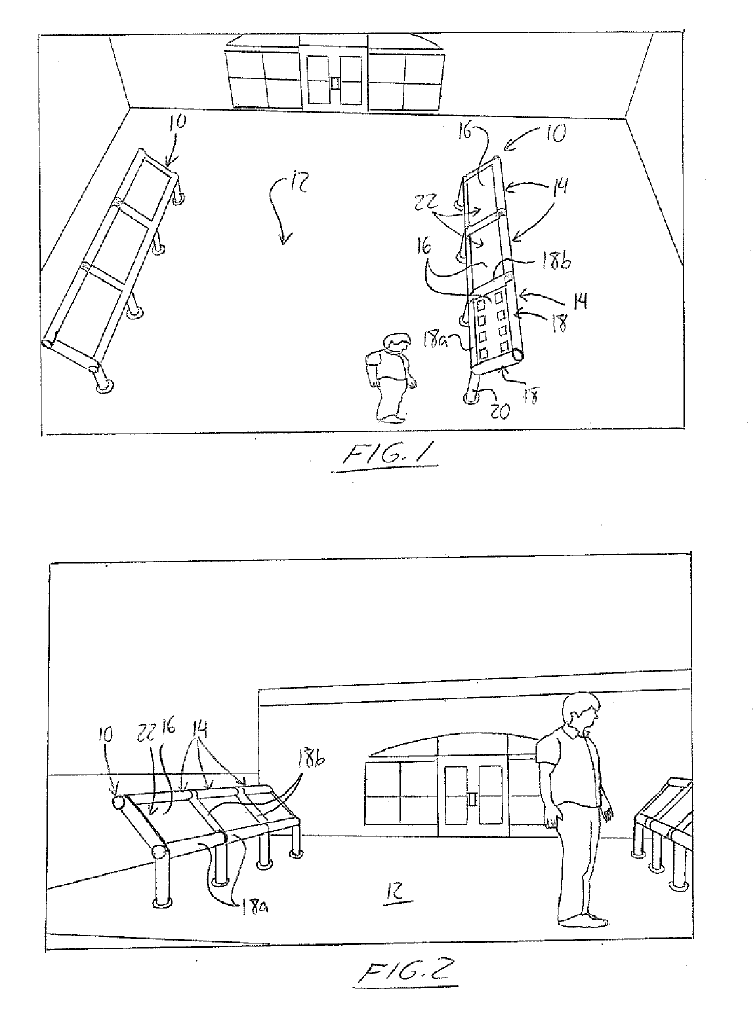

FIG. 1 is a birdseye view of a Lifetime Athlete Walkway of Honor constructed or installed at the campus a university or other educational entity in order to serve as a display site for recognitional plaques or tiles that are each customized with the name of an athletic alumni member and mounted on display in exchange for a financial contribution made to the educational entity. The installation can thus be used to generate revenue on an ongoing basis, initially by setting up the Walkway of Honor and reaching out to existing athletic alumni for contributions in exchange for displaying a plaque reflective of each contributing alumnus, and then continuing in perpetuity by annually approaching graduating or freshly graduated athletes, or family thereof, with the same opportunity.

In the embodiment of FIGS. 1 to 4, the installation features two display sections 10 horizontally spaced apart from one another and each extending in a similar longitudinal manner along the ground atop which the installation is disposed in order to leave a walkway or path 12 between the two sections 10. Each section 10 is made up of a series of display stands 14 arranged side by side along the respective side of the walkway 12 and each presenting a display face 16 lying in an oblique plane facing upwardly and inwardly toward the walkway space between the sections 10. Each display face is of a rectangular area bound on its four sides by frame members 18 of metal tubing or other suitably rigid material and structure. Of these frame members of each display face, a front frame member 18a oriented along the pathway and nearest thereto features a pair of upright support posts 20 fixed to the ground at its opposing ends to carry the four frame members and the display face at an elevation above the ground level walkway. Each support post may be anchored to the ground by a horizontal base plate perpendicular to the longitudinal direction of the post that features four (or another) fastener holes through which they can be anchored to concrete or other ground/walkway material. A stone panel 22 is mounted to the four frame members 18 to lie within the rectangular area bound thereby, presenting a planar rectangular top surface facing obliquely upward from between the frame members to define the display face 14 of the stand.

Prior to the installation at the walkway site, the stone panel 22 of each display stand 14 is pre-drilled with a rectangular array of exclusive mounting hole sets (not shown). In one embodiment, each mounting hole set is an exclusive pair of holes in which two holes through the panel 22 are horizontally spaced apart at equal vertical positions, with the pairs laid out in five parallel rows and five parallel columns along the plane of the panel's upper display face. Each tile or plaque 24 features a pair of corresponding mounting holes adjacent opposite sides or ends of the plaque so as to each align with a respective one of the two mounting holes of each pair in the panel 22 to allow passage of a fastener 26 through the aligned holes at each side or end of the plaque to securely fasten the plaque 24 to the panel 22. Each panel 22 of the illustrated embodiment thus forms a backdrop or backing material onto which the plaques are to be mounted, and can accommodate up to twenty five equally sized plaques.

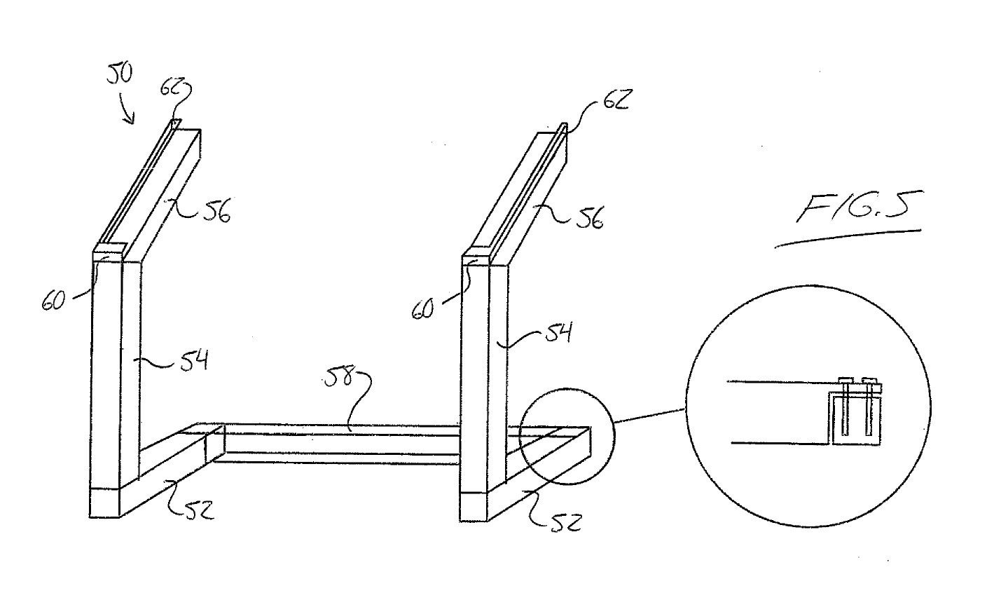

Referring to FIG. 4, each plaque 24 of the illustrated embodiment features the name of an athletic alumni member of the educational entity, identification of the year or years in which the alumni member was an active member of an athletic team or organization of the school, and identification of the position played by the alumni member in the case of positional team sports. One of the plaques of FIG. 4 demonstrates that the sport played by the alumni member may also be reflected in writing or graphical/illustrative form, as may be a team name or school/team logo. For example, the rectangular plaque nearest the center of FIG. 4 features a football illustration in the bottom right corner and a school logo at the top left corner.

The section 10 of the display structure on each side of the walkway is extendable by adding one or more additional display stands to the series of previously installed stands. In the embodiment of FIGS. 1 to 4, each pair of adjacent stands in the series shares a common side member 18b of the frame between the panels 22 of the stands and a common support post 20 below this shared side member 18 between the front frame members 18a of the two stands. Accordingly, the section can be extended by one stand at any time after the initial construction by adding front and rear frame members, a single side member, single post and single panel to an existing stand at the end of the series (or to the only stand if the section is initially constructed to have only a single stand). Accordingly, as the originally installed stands approach or reach their capacity of plaques as more athletes contribute to the school over time, the overall area for displaying plaques can be increased as needed.

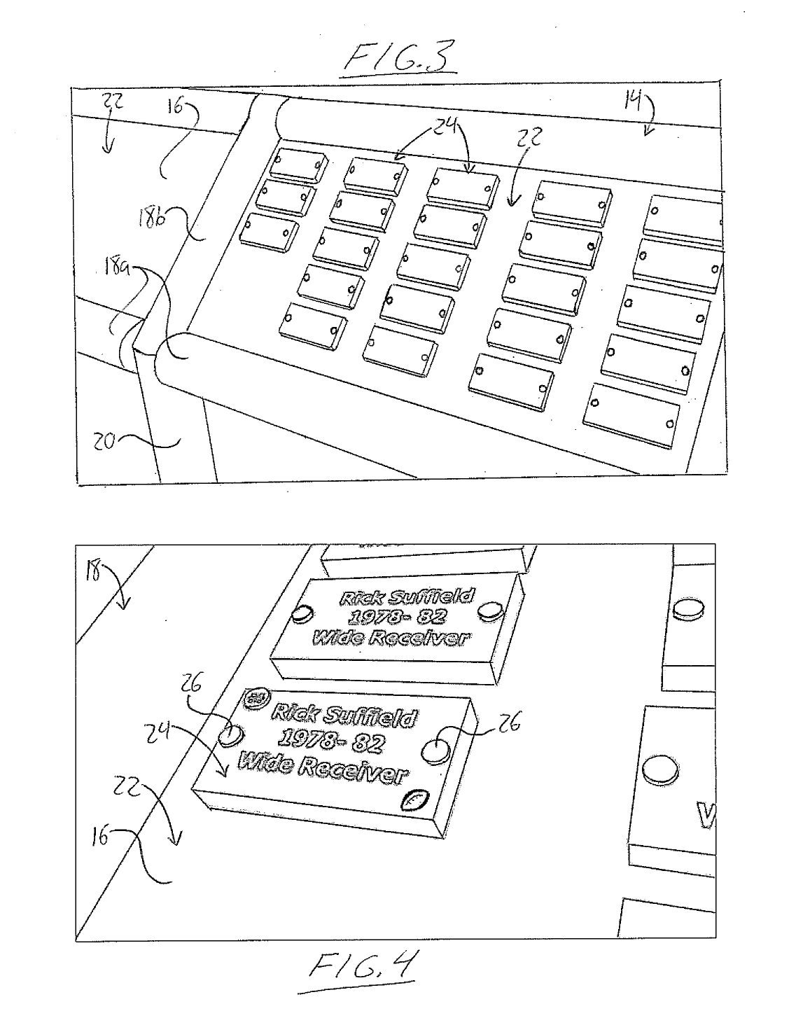

As demonstrated in FIG. 2 by the naming of a building to which the Walkway of Honor leads, whether having been constructed at an approach to an existing building or erected as part of the building construction process, naming rights for the installation or a site or location at which it has been or will be installed can be sold to a sponsor in exchange for contribution to the initial construction of the Walkway of Honor. Accordingly, the expense to the school for the initial setup of the Walkway of Honor can be kept relatively low, or even eliminated entirely, in order to maximize revenue brought in by contributions from the athletic alumni contacted with an offer to purchase a customized plaque. The building in the schematic illustration is labeled as a stadium, reflecting the possibility of installing the Walkway of Honor at the site of a building or structure associated with athletics, whether a stadium, pool, track centre, ice rink, gymnasium, outdoor track, pitch, field or other such location. However, it will also be appreciated that the location of the Walkway of Honor need not necessarily be directly linked to a sporting facility. While the illustrated embodiment is located outdoors, alternate embodiments may feature indoors installations, although this may hinder the expandability of the walkway as the number of plaques to display increases over time.

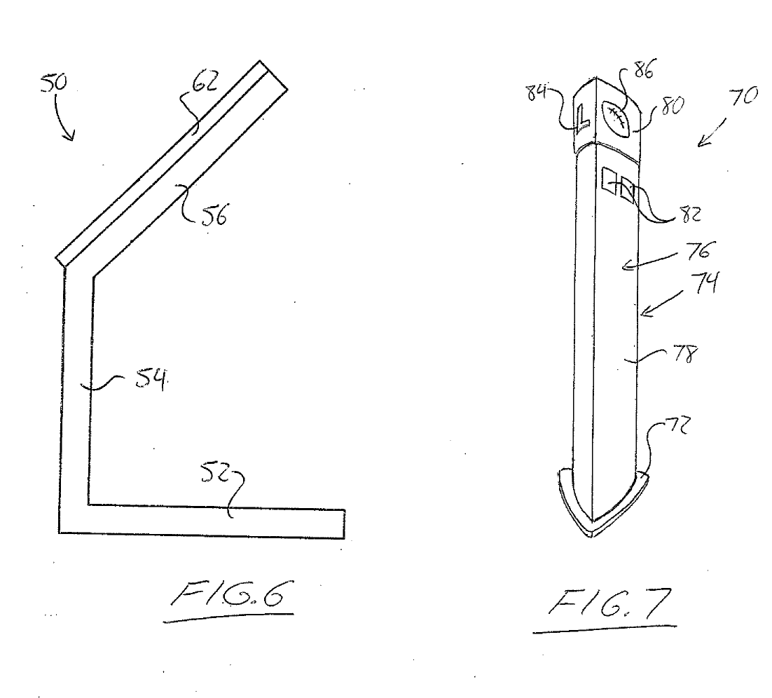

FIGS. 5 and 6 illustrate an alternate embodiment display structure in which each stand 50 features linear pieces of square metal tubing, for example stainless steel, fixed together to form a frame of the stand. At each side, the frame features a side assembly formed primarily by three pieces of tubing rigidly fastened-together to lie in a common vertical plane. Each such side assembly feature a horizontal first piece 52 fixed to vertical a second piece 54 projecting upward at one end of the first piece to form an L-shaped base, and an inclined third piece 56 projecting obliquely upward from the top end of the vertical second piece 52 over the horizontal first piece 52. An additional piece of linear tubing 58 horizontally and perpendicularly interconnects the two side assemblies at the ends of the assemblies' horizontal pieces opposite their vertical pieces.

The three horizontal pieces of the resulting stand sit flat atop the ground or walkway material, with the pieces of the two side assemblies being identically dimensioned so that each piece of one side assembly aligns with the respective piece of the other side assembly. The inclined pieces 56 present an obliquely oriented support structure for a panel on which the plaques are mountable in order to present a display face upwardly facing toward the walkway like in the first embodiment so as to be readily viewable from passersby traversing the walkway. The vertical pieces, corresponding to the upright support posts of the first embodiment, thus define a front end of the stand, with the interconnecting piece between the two side assemblies defining an opposing opposite end. The length of the interconnecting piece is selected to space apart the end assemblies by a suitable amount such that the backing panel on which the plaques are to be mounted can spans across the inclined pieces to rest thereatop.

The inclined pieces 56 of the two side assemblies each feature front and outer right angle walls 60, 62 extending along the front end and outer side edge of the piece's rectangular top surface. Each right angle wall first projects perpendicularly upward from this top surface of the tubing piece and then juts out inward over a portion of this surface. The two side assemblies differ only which side of the inclined tubing piece the outer right angle wall 62 is disposed, the resulting two side assemblies of each stand therefore each being a mirror image of the other across a central vertical plane cutting perpendicularly through the interconnecting piece 60 at the rear of the stand. The panel slides onto the inclined pieces 56 from the rear ends thereof between the top surface of these pieces and the top jutting portions of the right-angle walls parallel to the top surface at a distance thereover, the right angle walls thus keeping the panel securely seated in this stationary position atop the inclined pieces 56 by blocking sliding of the panel off the front or outer side of each inclined piece.

The stand frame of FIGS. 4 and 5 may be produced in separate pieces or subassemblies for shipping in a flat-pack manner for final assembly at the Walkway site. To balance ease of installation with such space and cost efficient shipping, each side assembly may be preassembled by the manufacturer for shipping of each stand frame in three parts: left and right side assemblies each featuring the three tubing pieces and two right angle walls already welded or otherwise fixed together, and an interconnecting piece to extend across the rear of the stand to separate the two side assemblies at the appropriate distance. Alternatively flat pack options may include shipping of all tubing pieces of the stand frame as separate units to be fastened together on site or other combinations of preassembled tubing pieces, but in any case preferably at least with the panel-retaining right-angle walls pre-installed on the respective tubing pieces.

The stand of FIGS. 4 and 5 is self-supporting by mere seating of the horizontal pieces on a suitable flat ground surface, but further anchoring of each stand to the ground may be implemented for improved securing of the stand. Stands may be seated or anchored to the ground in a side-by-side manner along a side of the walkway like the embodiment of FIGS. 1 to 4. It will be appreciated that although the stands of FIGS. 1 to 4 are configured in linear sections along opposite sides of a straight walkway, that other embodiments may have the display sections follow along a curving path or along different linear sections of a walkway diverging from a purely linear path between its ends. Also, the installation need not necessarily have displays set up on both sides of the walkway. For example, a single row of stands having an open path for foot-traffic to move past the stands in close enough proximity thereof for viewing of the displayed athlete information may likewise form a Walkway of Honor.

To provide a sturdy, durable, long-lasting installation able to withstand ongoing exposure to the elements or other wear and tear, stone panels; steel frame members, tubing or railings; and stone plaques or tiles may be used to produce the overall display structure, for example using stainless steel framework and granite plaques and backing panels. These are of course only examples, and are not intended to limit the scope of the present invention. The plaques or tiles of the illustrated embodiment are shown as rectangular tablets of stone carved to leave raised lettering, but it will be appreciated that the type, size, shape, material and means of displaying readable information may each be varied without departing from the scope of the present invention. For example, metal display elements, whether as stand alone pieces mountable on the display structure or fixed onto a stone tablet, may provide life-long durability and may use etching or other processes to create readable information during the customization of each display element to reflect the information of the respective contributing athlete. Other embodiments could potentially even employ electronic displays programmed or configured to allow entry of the desired athlete information to be displayed, whether multiple displays are added to the installation over time each for an individual contributor or whether a single display is operable to add to a list of contributors, for example a large display capable of showing a large list of contributors on a single stationary view or a smaller display arranged to scroll through the list or transition through sub-sets of the list.

The vision behind the Walkway of Honor is that an athletic director would ideally like to engage “all” his/her former athletes in a one-time contribution for a lifetime of involvement. For example, it may be desirable to be able to involve any athlete that participated in any sport since 1950 to join the school's Lifetime Athlete Walkway of Honor. There are three motivational components to the Walkway of Honor:
1—for the athlete to be honored and recognized on their University campus for life as a former player and member of The Team to celebrate the memories of their athletic experience;
2—to Honor and support present athletes in their quest for excellence. (meal per diems, exhibition competition, tutors, off-season training and testing new training center, scholarships, academic endowment, equipment, assistant coaches, etc.);
3—to provide a Legacy (scholarship/endowment) for future athletes to have all the resources necessary to develop to their full potential and assist coaches in recruiting Blue Chip athletes into the school's various athletic programs;

The process may involve any athlete that played on any team in the history of the school to participate in the Athlete Walkway of Honor. The all-conference all-star-the league all-star-the top scorer-the defensive specialist-the role player-the Red-Shirt-the most talented-the athlete who used effort to overcome natural ability-the athlete that was selfish but can now make amends-the athlete that was just proud to be part of the team-the athlete who would not have graduated if it were not for the sport they were involved with-the athlete who met their significant other while at the school-an athlete who got a job or job opportunity from a teammate he/she played with-an athlete that learned a lot about life qualities from a dedicated and concerned coach-an athlete that remembers how proud their parents were of seeing them represent their University as an athlete and how they sacrificed to attend their games-an athlete who can sit and laugh at a funny road trip event without anyone around-an athlete who meets a player from a team he/she competed against and share some interesting memories. Regardless of the details, many athletes will recall a significant contribution to their lives from their athletic involvement during their educational years-which may be viewed as priceless, and thus easily worth making a contribution to the school.

The generation of revenue through the process outlined herein provides two significant outcomes: 1) the raising of funds to enhance the quality of the athletic experience at the University, and 2) to establish a connection with all former athletes, whereby a venue is provided for them to be a continued part of the school's athletic family, be it in a big or smaller fashion. One embodiment of the process including steps for interaction among former and current athletes is outlined as follows:
1—Each contributor (former athlete) may have a plaque or tile of granite or other effectively life-lasting material with their name, team played on, position, and years they played placed on a Walkway of Honor. This created corridor (both sides) can be constructed on an existing walkway or sidewalk, leading into a major building on the campus, or at the entrance to a football or basketball stadium outside. The display rail of stainless steel or other rigid and durable material can also be adjusted and can be placed in an inside venue if preferred. The walkway is an excellent way to involve the many out of town former athletes, in that for every out of town athlete that wants to join the Athlete Walkway of Honor with their teammates, they can be recognized on the campus for life regardless of where they are located or reside at any point in time. The out of town alumni can have a connection to ongoing campus life regardless even if living at afar locations remote from the actual campus location.
2—Each team may have a member of the Walkway of Honor visit the team (for example, after a practice, etc.) on an occasional or regular (for example, monthly) basis and talk to the team about their experiences at the school and possibly a humorous story or two.
3—On each team's web-site, once a month (or at other intervals) a member of the Walkway of Honor may be featured in a “where are they now” story. This will allow alumni from their sport to see what happened to some of their former teammates. What are they doing? Where are they living? And possibly, maybe even more importantly, an e-mail address so they can re-connect if they choose.
4—One game/competition each year may be featured as a Walkway of Honor night/day in their respective sports. The contributors may each receive one or more tickets, for example up to four, which may be complimentary. There can be special events planned and all the attending members of the Walkway of Honor may have a picture taken with the Team that, for example, may be subsequently made available for downloading from the team's web-site, for example the following week. Corporate sponsors can be involved in fun activities that promote their brand. The motto here is if it is fun, they will attend.

Based on the scenario presented thus, it is Applicant's opinion that a good percentage of former athletes that can be contacted will be highly interested in participating. The necessary activation in the program is provided for them and they are recognized for life as a member of THE TEAM. Such desire for recognition is a common goal, and in this case they are supporting the spirit of their former selves at the age of their lives where they were involved in school athletics—full of enthusiasm, excitement for the future, and “sky is the limit” type philosophy. By participating, the athletic alumni are support their former lifestyle for all future athletes to enjoy what they once experienced.

To start the process, first and foremost the school staff may research to the best of their ability to locate addresses, phone numbers or e-mail addresses for as many past school-athletes as they ca, for example from 1950-2010. Each contactable athletic alumni member represents a potential contribution. Different contribution levels within a predetermined range may be presented to the contacted parties, for example ranging from $300-$1500. However, it may be left up to each specific educational institution to decide on the contribution dollar value required for the former athlete to have their plaque placed on their Lifetime Athlete Walkway of Honor.

Each contribution may receive a full tax receipt for income tax exemption on the donation, and the payment and application form may be made available on a web-site for easy access. Different payment options may be made available, of course including a one-time payment in full and optionally including installment options, for example payments spread over annual payments or other intervals.

The educational entity may acquire a Title sponsor for a one-time contribution to be recognized as the sponsor of the Lifetime Athlete Walkway of Honor. There is great potential value to this, which may be used or partially used to construct the display installation.

Given the fact that most school's already have a substantial base of alumni the potential revenue could be huge, as demonstrated by the following examples using a $500 average contribution:

1000×$500=$500000

3000×$500=$1,500,000

5000×$500=$2,500,000

The passion to be part of the Walkway of Honor Society would encourage located former athletes to pass on to other former athletes the information about the endeavor. The idea is to have contributors indirectly become promotional/sales agents for the educational entity.

To keep the tradition of the Lifetime Athlete Walkway of Honor going in perpetuity, beginning in the first year after the program is initialized or after an initial mass outreach to known or located alumni is completed, the athletic department or other organization within the educational entity may contact the families of all the graduating athletes to consider a family/relative's gift (contribution) for their son/daughter to have their plaque placed on the Lifetime Athlete Walkway of Honor. This plaque (tile) may be presented to them on senior night of their final year before mounting on the Walkway.

The process of generating revenue may employ some or all of the following steps:

A—Use all available resources to locate all former athletes from all sports, for example within a selected time period, for example from 1950-2010. Different possible resources useful in this step include coaches, sport information directors, alumni offices, university school paper archives, use of media ranging from radio announcements to a large newspaper ad to help find missing athletic alumni.
B—Acquire a Corporate Title Sponsor with a onetime contribution for a lifetime of recognition for the Athlete Walkway of Honor. This should involve realistic picture of how being the Title Sponsor will benefit them in terms of exposure, relationships, events, and brand recognition.
C—Have a morning (breakfast) or other retreat/event involving all the staff responsible for the success of this Revenue Generating Plan with the Athletic Director. He/She will outline the clear vision and desired outcome of the venture as well as the benefits for the future. It is a team function that will likely require having everyone on board and assigned a task.
D—Once timing to announce the program is decided, the campaign may be kicked off with a press conference with the Title Sponsor present. Each Head Coach in the program may be present with committed alumni, preferably a notable number such as ten, from their sport that will demonstrate enthusiasm and endorse the Lifetime Athlete Walkway of Honor.
F—A quality, well-designed colored brochure with a visual of the desired Athlete Walkway of Honor and relevant information may be mailed to every available former athlete. In this day and age, e-mails and text messaging can easily be deleted without really understanding the intent and benefits of this Revenue Generating Plan, but these or other alternate communication methods may still be additionally or alternatively employed to present the plan to identified alumni. Follow up by phone may be employed, for example for those not heard from within a month of the original deployment of information on the project. The mass outreach for contributions may be made a onetime opportunity to be involved, as once the original Athlete Walkway of Honor is constructed the additional plaques will be for the graduating athletes in perpetuity.

One possible time line for this project could be from 6-8 months for completion as set out in this example:
1—November 1^{st}-January 31^{st} have all mailing addresses acquired and brochure ready.
2—February—Introductory press conference (above) and confirmation that the Lifetime Athlete Walkway of Honor will be completed by August 1^{st} for the beginning of the next athletic season. February and March will be two months to receive the revenue and commitment to be part of the Athlete Walkway of Honor from former athletes. This must be well organized and efficient in order to accomplish the desired goal.
3—April—Order all the plaques required and make sure the information material on each athlete is correct and double checked. Order the stainless steel or other frame assembly apparatus to accommodate your number of plaques such that everything can be received by July 1^{st}.
4—July—Have the Walkway completely assembled, including the recognition insignia of your Title sponsor at the beginning of the Walkway.
5—The Athletic Director will set a date early in September just after school begins and invite as many former athletes that have contributed to attend an official opening of the Athlete Walkway of Honor. University dignitaries, coaches, academic staff, media, celebrities, and your Title Sponsor should be in attendance and make it a special event.

Although preferred embodiments of the present invention are preferably implemented on a one-time contribution basis where an athletes plaque, tile, tablet or other display is kept up for life (e.g. for the life of at least one of the athlete, the school, or the athletic team the athlete was a member of) based on a single one-time financial contribution, it will be appreciated that other embodiments may employ an on-going contribution process where a contributing athlete is queried about making a further contribution to maintain the display, instead of being removed from a contact or contribution-request listing.

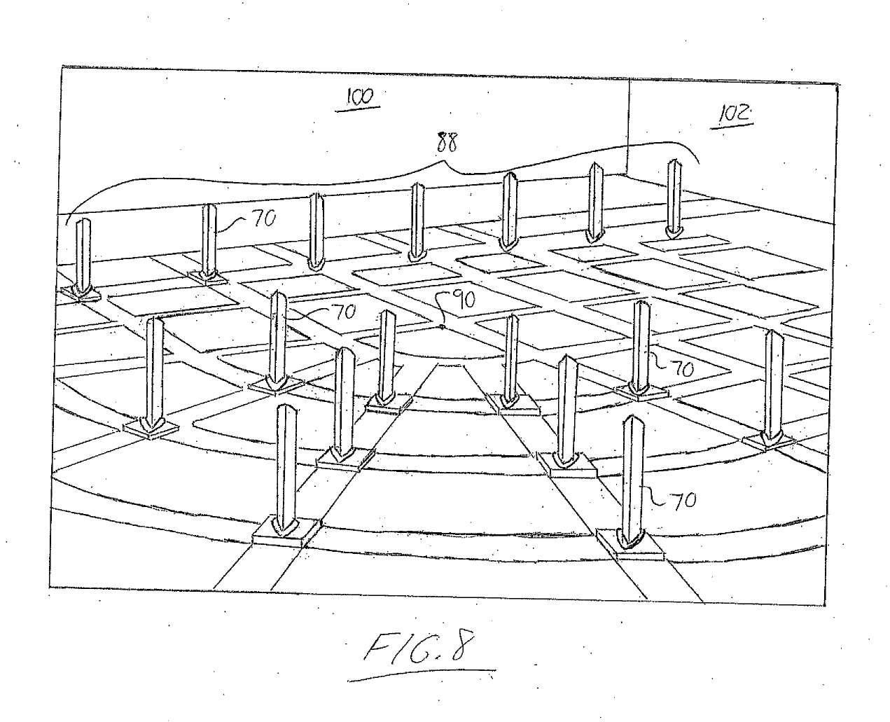

FIG. 7 shows a display tower 70 that may be used in place of the display stands of FIGS. 1 to 6. The stand has a column or pillar-like shape featuring a flat horizontal base plate 72 presenting a planar bottom face for seating against the ground or other support surface on which the tower is erected and a planar top face on which the bottom end of a hollow vertical upright 74 of the tower 70 is seated. In the illustrated tower embodiment, the base plate and the corresponding horizontal cross-section of the upright 74 are both of a three-sided shape equal or similar to a Reuleaux triangle. The uprights 74 thus features three vertical walls that are connected together end to end and each present an outwardly facing convex display surface 76. The illustrated display surfaces 76 are each divided into upper and lower sections 78, 80.

The lower section 78 spans from the base plate 72 upward over most of the upright's height, thus presenting a display area in which a number of athlete display elements 80 can be displayed, for example in two or more vertical columns running along the height of the lower section 78. FIG. 7 shows a first row of two such display elements 82 near the top of the lower section 78, below which further display elements can be added to fill out two columns spanning down along the lower portion. Multiple columns of athlete information per display area are preferred to increase the number of athletes displayable on each tower, and may include more than the two columns of the illustrated tower embodiment. On the other hand, each side of the upright may alternatively feature a single column of athlete information, i.e. only one athlete at any given height along the lower section 78 of the display area 76. The display elements may be printed inserts that can each be added to the walls of the display tower either before or after the erection thereof at the selected walkway site. Existing technology for producing long lasting, durable, graphic panels resistant to moisture, the elements and UV exposure for intended outdoor use can be employed to generate printed inserts for the display towers, resulting in display elements that can reasonably be expected to last at least ten years in an outdoor environment. Revenue from the perpetual aspect of the walkway program can be used to cover any required maintenance, including the replacement of inserts as the need arises.

The upper section 80 of the display area of each outer wall of the tower upright 74 may feature a team name or logo 84 or an indication of a particular sport type 86. The sport type indicator may spell out the name of the sport or may be a printed, punched, embossed, etched or engraved graphical representation of some sort, such as the football shown on the right wall of the tower in FIG. 7. Each upper section 80 may feature a single such sport indicator, in which case all of the athlete display elements 82 on the lower section 78 of that respective wall's display area are for athletes who were involved in that particular sport. In another embodiment, there may be provided multiple indicators on the upper section, each marking the sport of a respective column of athlete display elements 82 on the lower section of that wall. In such cases where one or more sport indicators are presented separately from the athlete display elements, the amount of information to be displayed on each customized athlete display element can be reduced compared to embodiment in which each customized athlete display element marks a particular sport in which that athlete participated. A single tower may be limited to only one particular sport, or may display the information of athlete's of different sports. In the latter case, different sides of the multi-sided tower may be dedicated to different respective sports.

As illustrated by the embodiment of FIG. 8, a lifetime athlete walkway of honor need not necessarily be configured as a single path having displays positioned therealong. FIG. 8 shows a walkway in the form of an outdoor space located between two perpendicular wings 100, 102 of an L-shaped building. The walkway has been configured with multiple sets of display towers of the type shown in FIG. 7. Each set consists of a plurality of towers arranged at spaced apart positions along a straight line. A first set 88 of towers are aligned parallel to one wing 100 of the building along an approach to an entrance of the second wing 102 of the building. The other sets of towers are arranged on respective radial lines extending from a central point 90 located off to one side from the first set 88 of towers. Each tower in the radial sets lies on a same arcuate path centered on the central point 90 as a respective tower in each other radial set of towers. Accordingly, any two adjacent radial sets have a pathway between them that extends linearly away from central point 90 while widening in this direction. Any two adjacent arcuate sets of towers have a respective arcuate pathway between them that extends arcuately around the central point 90. These radial and arcuate paths each thus have a series of display towers spaced each of its two sides. The overall walkway space thus allows viewers to wander or explore various possible paths through the space to view all or some of the display towers, or expose different passersby to different display towers depending on their selected path through the space.

The use of multi-sided display towers increases the number of directions from which athlete information is viewable compared to the embodiments of FIGS. 1 through 6, in which only a planar single display area is provided per display stand. The three-sided display towers of the radial tower sets of FIG. 8 have two sides facing two respective radial paths through the walkway space, and a third side facing a respective arcuate path around the central point 90. Two different display areas of each tower in the first tower set 88 are visible from one side of the row of the towers depending on which direction one is walking along the row, with the third display area of each tower of this row visible from the other side thereof.

The above display embodiments are only examples, and other tower, sign Panel(s), Display or Pylori may be employed, whether it is: round, curved, angled, square, rectangular, oval, or any shape not mentioned here that contains Athletes names on these panels. Athletes names may be provided on mountable plaques or tablets, on Insert Panels or be directly applied to display structures of such mentioned shapes by printing, etching, embossing, carving, etc. The display surface of above mentioned shapes may be flat, curved to any of various degrees, and may be defined by walls, panels or other structures of varying thicknesses. Possible configurations include Single Side Viewable, 2 sided viewable, 3 sided viewable, 4 sided viewable, 5 sided viewable or more, whether it is round, square, Oval, etc. and regardless of diameter. Displays may be mounted to extend horizontal or vertical relative to grade, and may be mounted to concrete, or any other surface material, indoors or outdoors.

The walkway of honor program may include appointment of an ambassador to be a liaison person for the teammates from his/her era. The ambassador may be appointed by a person or group in charge of the program, the athletic director or head coach(es). Each ambassador may be requested to attend a press conference to announce the Lifetime Athlete Walkway of Honor. They will support the venture with their commitment to be on the Walkway as well as be available for comments to any media turn out, and additionally any handout package for the media may include acknowledged of the ambassadors under their team heading, for example along with the Head Coach.

In addition to other goals or objects mentioned elsewhere herein, the Lifetime Athlete Walkway of Honor may accomplish the following.
1—Improving the brand of an athletic program on campus with a history of former players acknowledged on beautiful display towers in front of the selected venues. Students and staff walk by these daily. All the fans attending baseball, volleyball, hockey, and track and field events at the university, community or other level may see this display.
2—Every year numerous freshmen attend orientation sessions on campus, providing a great opportunity to show them the history of athletes. Spring and Fall graduation ceremonies are other opportunities to showcase athletes on campus.
3—Universities typically have significant rental businesses for leagues, clinics, and business conferences that will again provide an opportunity to educate the public about the history and people that have been a part of the athletic program.
4—With future team festival reunions planned with an alumni office, the walkway would be a great place to meet to start the reunions, letting athletes see their place in the university sport history with teammates.
5—The alumni activation part of the Lifetime Athlete Walkway of Honor provides opportunity to recognize alumni on each team's web-site during the season in a “where are they now” segment. Alumni for recognition at games in the future by position. An example would be to honor all the quarterbacks that played football, point-guards from basketball, setters from volleyball, sprinters from track and field, goalies from hockey/soccer/lacrosse, etc. One or more games/events a year may involve bringing the Walkway of Honor participants and featuring them in fun activities, a photo opportunity with the team before the game/event, a meet with the players after the game/event, etc.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of generating revenue for an educational entity having an athletic department, the method comprising:
(a) arranging for current athletes or former athletes, or a combination thereof, having associations with the athletic department of the educational entity to each be presented with an option of having a display element customized to present viewable information on the athlete in exchange for a respective financial contribution;
(b) in response to receipt of each financial contribution, customizing the display element and display the information on the athlete thereon; and
(c) supporting the display element on a display supporting structure erected at an accessible location where a display presenting area of the display supporting structure is viewable by passersby of the display supporting structure;

2. The method of claim 1 comprising erecting the display supporting structure, then customizing the display element and supporting the display element on the display supporting structure at the viewable display presenting area.

3. The method of claim 2 comprising acquiring a sponsor and having the sponsor contribute to erection of the display supporting structure at the accessible location.

4. The method of claim 1 wherein the accessible location is on-site at a campus of the educational entity.

5. The method claim 1 wherein the information on the athlete includes identification of the athlete by name, and identification of at least one of a team on which the athlete played, a team position played by the athlete, and a year or years in which the athlete played.

6. The method of claim 1 wherein the display supporting structure comprises two series of support devices disposed on opposite sides of a walkway passing therebetween.

7. The method of claim 1 wherein the display supporting structure comprises a series of support devices each sized to accommodate a predetermined number of display elements thereon.

8. The method of claim 1 comprising, for a contributory athlete responsible for a respective contribution, removing said contributory athlete from a list of athletes to later again present the option of contributing.

9. The method of claim 1 comprising keeping each customized display element viewable at the display supporting structure without requiring further contribution from the athlete whose information is displayed on said customized display element.

10. The method of claim 1 wherein step (a) comprises having the option presented to athletic alumni of the educational entity.

11. The method of claim 1 comprising, for each year on an ongoing basis, carrying out step (a) for graduating athletes of the educational entity that year.

12. The method of claim 11 wherein the carrying out of step (a) and for the graduating athletes is carried out before expected graduation thereof.

13. The method of claim 1 wherein each display supporting structure is multi-sided and presents multiple ones of said display area, each facing a respective outward direction from said display supporting structure.

14. An athletic alumni display apparatus for an educational entity, the apparatus comprising:
a walkway;
a series of support devices disposed on at least one side of the walkway in a side by side configuration along the walkway, each support device defining a display face that is visible from the walkway and sized to accommodate multiple display elements at respective positions over the display face; and
a plurality of customized display elements each located on one of the support devices and each displaying information thereon on a respective alumni athlete of the educational entity.

15. The apparatus of claim 14 comprising two of the series of support devices on opposing sides of the walkway.

16. The apparatus of claim 14 wherein each series of support devices is expandable by adding additional support devices to the series to accommodate additional customized display elements.

17. The apparatus of claim 14 wherein the display face of each support device is equally sized to each fit a same predetermined number of equally sized ones of the display elements.

18. The apparatus of claim 14 wherein each display device comprises a backing material supported by and spanning between frame members to define the display face on which the plurality of customized displays are seated.

19. The apparatus of claim 14 wherein each display device is multi-sided, one side of the display device defining the display face and one or more other sides defining one or more additional display surfaces each facing outwardly from the display device in a different direction than the display face.

20. The apparatus of claim 14 wherein the display elements are independent units that are distinct from the support devices and individually mounted thereon.
